(19) United States
(12) Patent Application Publication
(10) Pub. No.: US 2014/0032412 A1
(43) Pub. Date: Jan. 30, 2014

(54) Payment system and method for vending machine using mobile terminal and storage medium storing program for implementing the method

(71) Applicant: HAREXINFOTECH INC., Seoul (KR)

(72) Inventors: Kyung Yang Park, Seoul (KR); Hoon Joon Jeong, Gunpo (KR)

(21) Appl. No.: 13/927,379

(22) Filed: Jun. 26, 2013

(30) Foreign Application Priority Data
Jun. 26, 2012 (KR) 10-2012-0068469

(51) Int. Cl. G06Q 20/18

(52) U.S. Cl. CPC G06Q 20/18
USPC 705/44

(57) ABSTRACT

Disclosed herein are a payment system and method for a vending machine using a mobile terminal. The apparatus includes a mobile terminal, a service provider server, and a vending machine service provider server. The mobile terminal obtains the ID information of the vending machine from a tag attached to the vending machine, displays the amount of money to be paid for a product on a screen, and stores a receipt for the amount of money to be paid. The service provider server receives payment request information from the mobile terminal, approves the amount of money to be paid, and generates a transaction serial number. The vending machine service provider server receives the ID information, the transaction serial number, and the amount of money to be paid from the service provider server, and sends the information about the amount of money to be paid to the vending machine.

### CROSS-REFERENCE TO RELATED APPLICATIONS

This application claims priority to and the benefit of Korean Patent Application No. 10-2012-0068469 filed in the Korean Intellectual Property Office on Jun. 26, 2012, the entire contents of which are incorporated herein by reference.

### BACKGROUND OF THE INVENTION

1. Field of the Invention

The present invention relates to a payment system and method for a vending machine using a mobile terminal and a storage medium storing a program for implementing the method.

2. Description of the Related Art

An automatic vending machine (hereinafter referred to as the “vending machine”) is a machine for automatically discharging a product desired by a purchaser when the purchaser inserts money or a card into the machine. The vending machine functions as an unmanned store for selling daily household items, such as beverages, food, tobacco, tickets, newspapers, magazines, stamps, socks, wastepaper, and hygiene items. A conventional automatic vending system for purchasing a product using a mobile phone will be described below.

FIG. 1 shows the configuration of a conventional payment system for a vending machine using a mobile terminal. Referring to FIG. 1, the payment system for a vending machine using a mobile terminal includes a vending machine 22, a management server 23, and a mobile communication company server 24.

The vending machine 22 provides products to a purchaser 21, and a display 221 is installed in the vending machine 22.

When a request to purchase a specific product within the vending machine 22 is received from the mobile terminal of the purchaser 21, the management server 23 requests a payment from the mobile communication company server 24, connects to the vending machine 22 over a network, controls whether the vending machine 22 will discharge the specific product in response to a signal from the mobile terminal of the purchaser 21, and sends a receipt for the payment to the mobile terminal of the purchaser 21. The management server 23 includes a purchaser telephone number information database and a vending machine product database.

The mobile communication company server 24 stores data regarding deposits that were previously deposited by a purchaser. When information about a telephone number and a payment request are transmitted by the management server 23, the mobile communication company server 24 provides information about the telephone number, and approves the payment.

However, the conventional payment system for a vending machine using a mobile terminal is problematic in that deposits should have previously been made when a product sold by the vending machine is paid for and the product cannot be easily paid for by obtaining ID information of the vending machine from a tag attached to the vending machine.

### SUMMARY OF THE INVENTION

Accordingly, the present invention has been made keeping in mind the above problems occurring in the prior art, and an object of the present invention is to provide a payment system and method for a vending machine using a mobile terminal, wherein when paying for a product sold in a vending machine, a purchaser can obtain the ID information of the vending machine from a tag attached to the vending machine and conveniently pay for the product using a mobile terminal even without previously made deposits, and a storage medium storing a program for implementing the method.

In accordance with an aspect of the present invention, there is provided a payment system for a vending machine using a mobile terminal, including a mobile terminal configured to obtain ID information of the vending machine from a tag attached to the vending machine, to display an amount of money to be paid for a product sold by the vending machine in response to user input using a PIN number or biometric information for payment for the product on a screen, and to store a receipt for the amount of money to be paid after a service provider server has approved the amount of money to be paid; the service provider server configured to receive payment request information from the mobile terminal, to approve the amount of money to be paid, and to generate a transaction serial number; and a vending machine service provider server configured to receive the ID information, information about the transaction serial number, and information about the amount of money to be paid from the service provider server, and to send the information about the amount of money to be paid to the vending machine so that the product can be sold by the vending machine when the product is selected; wherein the vending machine service provider server receives information about a transaction of the product from the vending machine and sends the information about the transaction to the service provider server; wherein the service provider server requests a financial service provider server to approve the payment for the product, receives approval information regarding the payment for the product from the financial service provider server, and sends the approval information to the mobile terminal; wherein the mobile terminal accesses the service provider server and checks the approval of the payment for the product and details of the payment; wherein the payment request information comprises the ID information of the vending machine, a payment bank, and the amount of money to be paid; and wherein the ID information of the vending machine, the payment bank, and the amount of money to be paid are displayed on the screen of the mobile terminal when a payment request application program is executed on the mobile terminal, and the ID information of the vending machine is extracted and displayed on the screen of the mobile terminal.

In accordance with another aspect of the present invention, there is provided a payment system for a vending machine using a mobile terminal, including a mobile terminal configured to obtain ID information of the vending machine from a tag attached to the vending machine, to display an amount of money to be paid for a product sold by the vending machine in response to user input using a PIN number or biometric information for payment for the product on a screen, and to store a receipt for the amount of money to be paid after a service provider server has approved the amount of money to be paid; and the service provider server configured to receive payment request information from the mobile terminal, to approve the amount of money to be paid, to generate a transaction serial number, and to send information about the amount of money to be paid to the vending machine so that the product can be sold by the vending machine when the product is selected; wherein the service provider server receives information about a transaction of the product from the vending machine, requests a financial service provider server to approve the payment for the product, receives approval information regarding the payment for the product from the financial service provider server, and sends the approval information to the mobile terminal; wherein the mobile terminal accesses the service provider server and checks the approval of the payment for the product and details of the payment; wherein the payment request information comprises the ID information of the vending machine, a payment bank, and the amount of money to be paid; and wherein the ID information of the vending machine, the payment bank, and the amount of money to be paid are displayed on the screen of the mobile terminal when a payment request application program is executed on the mobile terminal, and the ID information of the vending machine is extracted and displayed on the screen of the mobile terminal.

In accordance with an embodiment of the present invention, there is provided the payment system, wherein the tag is a printed matter or an electronic tag that is one of a Quick Response (QR) code, a Radio Frequency (RF) tag, a Near Field Communication (NFC) tag, or a barcode; and the QR code or the barcode is displayed on the screen of the mobile terminal.

In accordance with another embodiment of the present invention, there is provided the payment system, wherein the ID information of the vending machine is a combination of an area where the vending machine has been installed and a vending machine number which has been assigned within the area.

In accordance with still another embodiment of the present invention, there is provided the payment system, wherein the financial service provider server is any one of a credit financial service provider server, a bank server, an electronic money company server, a prepaid service provider server, and a point service provider server.

In accordance with still another embodiment of the present invention, there is provided the payment system, wherein the user input is PIN input or biometric input.

In accordance with still another embodiment of the present invention, there is provided the payment system, wherein the service provider server receives approval information regarding the payment for the product from the financial service provider server, and sends the approval information to the mobile terminal; and the mobile terminal accesses the service provider server and checks the approval of the payment for the product and details of the payment.

In accordance with still another embodiment of the present invention, there is provided the payment system, wherein the service provider server includes a Point Of Sale (POS) server configured to receive the payment request information from the mobile terminal; a Payment Gateway (PG) server configured to receive the payment request information from the POS server; and a payment server configured to receive the payment request information from the PG server, to approve the amount of money to be paid, to generate the transaction serial number, and to send the ID information, information about the transaction serial number, and information about the amount of money to be paid to the vending machine service provider server.

In accordance with still another embodiment of the present invention, there is provided the payment system, wherein the mobile terminal stores a receipt for the amount of money to be paid after the service provider server has approved the amount of money to be paid.

In accordance with still another aspect of the present invention, there is provided a payment method for a vending machine using a mobile terminal, including a first step of obtaining, by the mobile terminal, ID information of the vending machine from a tag attached to the vending machine; a second step of displaying, by the mobile terminal, an amount of money to be paid for a product sold by the vending machine on a screen in response to user input using a PIN number or biometric information regarding payment for the product; a third step of receiving, by a service provider server, payment request information from the mobile terminal, approving, by the service provider server, the amount of money to be paid, and generating, by the service provider server, a transaction serial number; a third-first step of storing, by the mobile terminal, a receipt for the amount of money to be paid after the service provider server has approved the amount of money to be paid; a fourth step of receiving, by a vending machine service provider server, the ID information, information about the transaction serial number, and information about the amount of money to be paid from the service provider server; a fifth step of sending, by the vending machine service provider server, the information about the amount of money to be paid to the vending machine so that the product can be sold by the vending machine when the product is selected; a sixth step of receiving, by the vending machine service provider server, information about a transaction of the product from the vending machine and sending, by the vending machine service provider server, the information about the transactions to the service provider server; a seventh step of requesting, by the service provider server, a financial service provider server to approve the payment for the product; an eighth step of receiving, by the service provider server, approval information regarding the payment for the product from the financial service provider server and sending, by the service provider server, the approval information to the mobile terminal; and a ninth step of accessing, by the mobile terminal, the service provider server and, by the mobile terminal, checking the approval of payment for the product and details of the payment; wherein the payment request information comprises the ID information of the vending machine, a payment bank, and the amount of money to be paid; and wherein the ID information of the vending machine, the payment bank, and the amount of money to be paid are displayed on the screen of the mobile terminal when a payment request application program is executed on the mobile terminal, and the ID information of the vending machine is extracted and displayed on the screen of the mobile terminal.

In accordance with still another aspect of the present invention, there is provided a payment method for a vending machine using a mobile terminal, including a first step of obtaining, by the mobile terminal, ID information of the vending machine from a tag attached to the vending machine; a second step of displaying, by the mobile terminal, an amount of money to be paid for a product sold by the vending machine on a screen in response to user input using a PIN number or biometric information regarding payment for the product; a third step of receiving, by a service provider server, payment request information from the mobile terminal, approving, by the service provider server, the amount of money to be paid, and generating, by the service provider server, a transaction serial number; a third-first step of storing, by the mobile terminal, a receipt for the amount of money to be paid after the service provider server approves the amount of money to be paid; a fourth step of sending, by the service provider server, information about the amount of money to be paid to the vending machine so that the product can be sold by the vending machine when the product is selected; a firth step of receiving, by the service provider server, information about a transaction of the product from the vending machine, and requesting, by the service provider server, a financial service provider server to approve the payment for the product; a sixth step of receiving, by the service provider server, approval information regarding the payment for the product from the financial service provider server, and sending, by the service provider server, the approval information to the mobile terminal; and a seventh step of accessing, by the mobile terminal, the service provider server, and checking, by the mobile terminal, the approval of the payment for the product and details of the payment; wherein the payment request information comprises the ID information of the vending machine, a payment bank, and the amount of money to be paid; and wherein the ID information of the vending machine, the payment bank, and the amount of money to be paid are displayed on the screen of the mobile terminal when a payment request application program is executed on the mobile terminal, and the ID information of the vending machine is extracted and displayed on the screen of the mobile terminal.

In accordance with an embodiment of the present invention, there is provided the method, wherein the tag is a printed matter or an electronic tag that is one of a QR code, an RF tag, an NFC tag, or a barcode; and the QR code or the barcode is displayed on the screen of the mobile terminal.

In accordance with another embodiment of the present invention, there is provided the method, wherein the ID information of the vending machine is a combination of an area where the vending machine has been installed and a vending machine number which has been assigned within the area.

In accordance with still another embodiment of the present invention, there is provided the method, wherein the financial service provider server is any one of a credit financial service provider server, a bank server, an electronic money company server, a prepaid service provider server, and a point service provider server.

In accordance with still another embodiment of the present invention, there is provided the method, wherein the user input is PIN input or biometric input.

In accordance with still another embodiment of the present invention, there is provided the method, further including receiving, by the service provider server, approval information regarding the payment for the product from the financial service provider server, and sends, by the service provider server, the approval information to the mobile terminal; and accessing, by the mobile terminal, the service provider server and checks, by the mobile terminal, the approval of the payment for the product and details of the payment.

In accordance with still another embodiment of the present invention, there is provided the method, wherein the third step includes receiving, by a Point Of Sale (POS) server, the payment request information from the mobile terminal; receiving, by a Payment Gateway (PG) server, the payment request information from the POS server; receiving, by a payment server, the payment request information from the PG server, approving, by the payment server, the amount of money to be paid, and generating, by the payment server, the transaction serial number; and sending, by the payment server, the ID information, information about the transaction serial number, and information about the amount of money to be paid to the vending machine service provider server.

In accordance with still another embodiment of the present invention, there is provided the method, further comprising, between the third and fourth steps, storing, by the mobile terminal, a receipt for the amount of money to be paid.

In accordance with still another aspect of the present invention, there is provided a storage medium storing a program for implementing any one of the above-described methods.

### BRIEF DESCRIPTION OF THE DRAWINGS

The above and other objects, features and advantages of the present invention will be more clearly understood from the following detailed description taken in conjunction with the accompanying drawings, in which:

FIG. 1 shows the configuration of a conventional payment system for a vending machine using a mobile terminal;

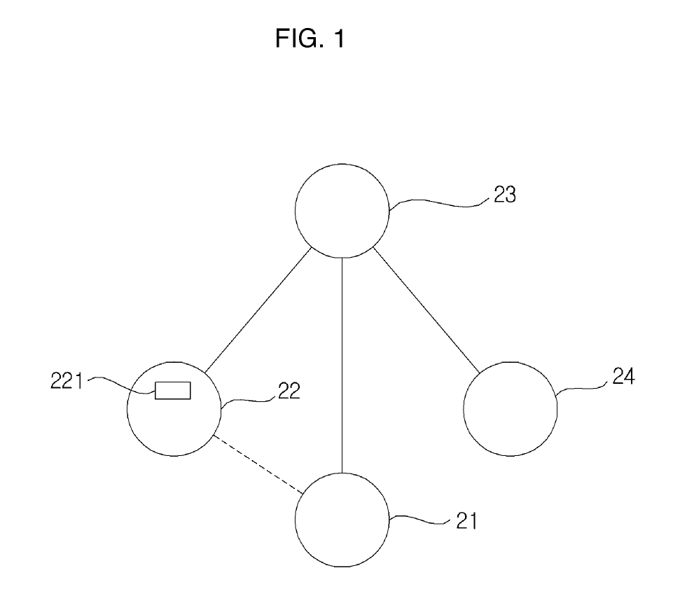

FIG. 2 is a block diagram of a payment system for a vending machine using a mobile terminal according to an embodiment of the present invention;

FIG. 3 is a flowchart illustrating a payment process in a payment method for a vending machine using a mobile terminal according to an embodiment of the present invention;

FIG. 4 is a flowchart illustrating a payment process within a service provider server in the payment method for a vending machine using a mobile terminal according to an embodiment of the present invention;

FIG. 5 shows the amount-of-money-to-be-paid input screen of a mobile terminal in the payment system for a vending machine using a mobile terminal according to an embodiment of the present invention;

FIG. 6 shows the payment screen of a mobile terminal in the payment system for a vending machine using a mobile terminal according to an embodiment of the present invention;

FIG. 7 shows the payment verification completion screen of a mobile terminal in the payment system for a vending machine using a mobile terminal according to an embodiment of the present invention; and

FIG. 8 is a screen in which the details of approval of the payment of a mobile terminal are checked in the payment system for a vending machine using a mobile terminal according to an embodiment of the present invention.

### DESCRIPTION OF THE PREFERRED EMBODIMENTS

Embodiments of the present invention will be described below with reference to the accompanying drawings. A variety of modifications and variations may be made to the embodiments, and the present invention is not limited to the embodiments. The shapes and sizes of elements in the drawings may be exaggerated in order to provide a clearer description, and like elements are designated by like reference numerals.

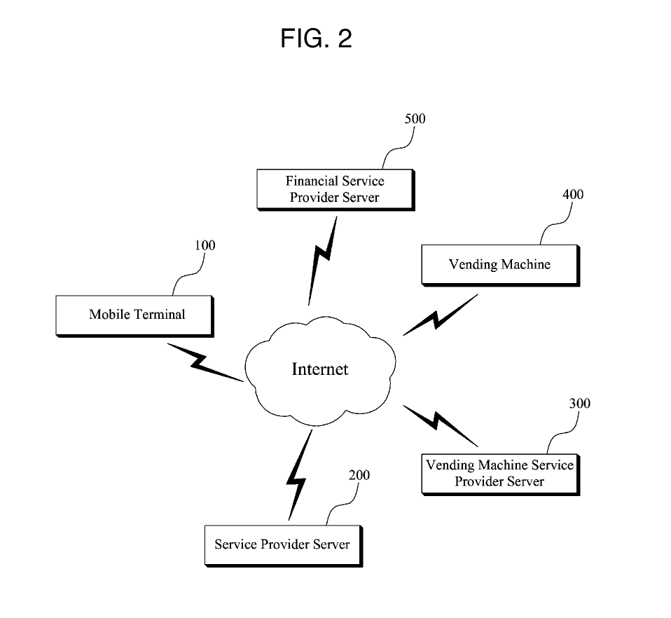

FIG. 2 is a block diagram of a payment system for a vending machine using a mobile terminal according to an embodiment of the present invention. Referring to FIG. 2, the vending machine payment system using a mobile terminal may include a mobile terminal 100, a service provider server 200, a vending machine service provider server 300, a vending machine 400, and a financial service provider server 500.

The mobile terminal 100 obtains the ID information of the vending machine 400 from a tag attached to the vending machine 400, and displays the amount of money to be paid for a product sold by the vending machine 400 on a screen in response to user input regarding payment for the product. The tag attached to the vending machine 400 is a printed matter or an electronic tag, such as a Quick Response (QR) code, a Radio Frequency (RF) tag, a Near Field Communication (NFC) tag, or a barcode. The QR code or barcode is displayed on the screen of the mobile terminal 100.

In order to obtain the ID information of the vending machine 400 from the tag attached to the vending machine 400 via the mobile terminal 100, it is necessary to download an application program, such as UBPay App., and then subscribe to the UBPay App. service. In order to install the UBPay App. program on the mobile terminal 100, a user needs to visit an app store or an app market and download the UBPay App. program. Once the UBPay App. program has been installed, a user may execute the UBPay App. program at any time and at any location.

Furthermore, the user input regarding payment for the product sold by the vending machine 400 may be the input of a PIN number or biometric information. The biometric information may be, for example, a fingerprint. If the user input is different from user input set in the mobile terminal 100, payment is not performed.

Furthermore, the mobile terminal 100 can access the service provider server 200, and can check approval of the payment for the product and the details of the payment. As will be described later, the service provider server 200 can approve the amount of money to be paid and generate a transaction serial number, and the mobile terminal 100 can store a receipt for the amount of money paid. Accordingly, a purchaser can ensure the receipt in order to provide for a case where the purchaser needs the receipt for the payment for the purchased product.

Furthermore, the mobile terminal 100 may be configured to be controlled from a remote location. If the mobile terminal 100 is configured to be controlled from the remote location, a person other than the purchaser may not use the mobile terminal 100 when the purchaser loses the mobile terminal 100. If the person other than the purchaser uses the lost mobile terminal 100, a message reading “Sorry! The mobile terminal service has been suspended” may be displayed on the screen of the mobile terminal.

Meanwhile, the mobile terminal 100 may be implemented in various forms. For example, the mobile terminal 100 may be a mobile phone, a smart phone, a notebook computer, a terminal for digital broadcasting, a Personal Digital Assistant (PDA), a Portable Multimedia Player (PMP), a navigator, an e-book terminal, a tablet PC, or the like.

The service provider server 200 receives payment request information from the mobile terminal 100, checks whether an approval limit has been exceeded, approves the amount of money to be paid if the approval limit has not been exceeded, and generates a transaction serial number. The payment request information may include the ID information of the vending machine 400, a payment bank, and the amount of money to be paid. The ID information of the vending machine 400 is the combination of an area where the vending machine 400 has been installed and a vending machine number which has been assigned within the area, and the amount of memory to be paid is displayed on the screen of the mobile terminal 100 in response to user input, such as keyboard input or voice input. The ID information of the vending machine 400, the payment bank, and the amount of money to be paid are displayed on the screen of the mobile terminal 100 when a payment request application program is executed on the mobile terminal 100. In particular, the ID information of the vending machine 400 is parsed, extracted, and then displayed on the screen of the mobile terminal 100. The mobile terminal 100 stores a receipt for the amount of money paid after the service provider server 200 has approved the amount of money to be paid.

Furthermore, the service provider server 200 receives approval information regarding the payment for the product from the financial service provider server 500, and sends the approval information to the mobile terminal 100.

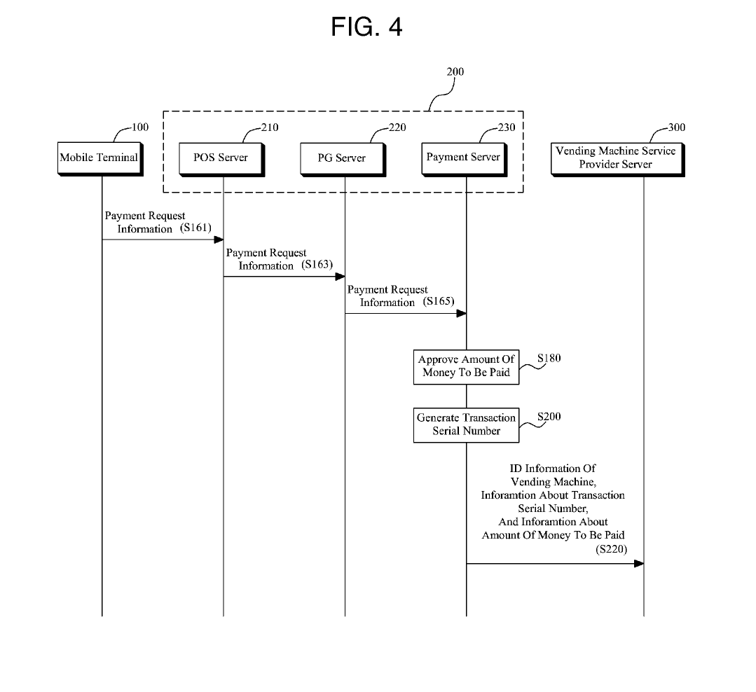

As described above, the service provider server 200 constructs an independent network, that is, a value-added communication network, by hiring a communication line from a public telecommunication service operator, and the service provider server 200 can be implemented as a Value-Added Network (VAN) server. The service provider server 200 does not provide simple communication service, but provides high value-added service, such as the exchange of various types of information in the form of code, video and audio, the accumulation of information, or the transmission of a plurality of pieces of information, over an independent network. The service provider server 200 includes a Point Of Sale (POS) server 210, a Payment Gateway (PG) server 220, and a payment server 230 (see FIG. 4).

The POS server 210 receives payment request information from the mobile terminal 100. The POS server 210 is a system that connects the vending machine 400 to a computer and manages product data. The POS server 210 collects data about a product name and a price when a product is sold, and manages the collected data using the computer. The POS server 210 based on the Web, which appeared with the development of the Internet, has its area expanded to a user's home or office. A variety of functions, such as sales management, profit and loss management, and inventory management, are converged into the POS server 210.

The PG server 220 receives payment request information from the POS server 210. A PG company operating the PG server 220 makes representative contracts with a financial service provider on behalf of small and medium shopping malls, which have difficulty making contracts with the financial service provider, and performs payment and settlement.

The payment server 230 receives payment request information from the PG server 220, approves the amount of money to be paid, generates a transaction serial number, and sends the ID information of the vending machine 400, information about the transaction serial number, and information about the amount of money to be paid to the vending machine service provider server 300.

The vending machine service provider server 300 includes a vending machine management database (DB). The vending machine management DB registers and manages the vending machine 400 managed by a vending machine service provider. In particular, the vending machine 400 is managed over a network. The vending machine service provider server 300 receives the ID information of the vending machine 400, a transaction serial number, and the amount of money to be paid from the service provider server 200, and sends information about the amount of money to be paid to the vending machine 400 so that the product selected by the purchaser can be sold by the vending machine 400. The vending machine service provider server 300 receives information about the transaction of the product from the vending machine 400, and sends the information about the transaction to the service provider server 200. The service provider server 200 requests the financial service provider server 500 to approve the payment for the product.

The vending machine 400 aligns products horizontally and vertically and then displays the aligned products so that the purchaser can easily check and select the products by the naked eye and lights up product buttons corresponding to products that can be purchased using the amount of money paid. Thereafter, prices are displayed under the corresponding products. A product exit through which a product selected by the purchaser can be taken out of the vending machine 400 is provided in the lower portion of the vending machine 400. When the product selected by the purchaser is sold by the vending machine 400, the product drops to the product exit so that the purchaser can take the product out of the vending machine 400. Furthermore, the vending machine 400 includes a change exit through which change, that is, the difference between the amount of money paid and the actual price of the product, can be discharged. The purchaser may take the change after the product has been sold.

The vending machine 400 may be applied to a variety of types of vending machines 400 for selling beverages, food, tobacco, tickets, newspapers, magazines, stamps, socks, wastepaper, and hygiene items, and may also be applied to any type of vending machine 400 capable of adopting the same selling method.

The financial service provider server 500 may be any one of a credit financial service provider server, a bank server, an electronic money company server, a prepaid service provider server, and a point service provider server.

As described above, in the payment system using a mobile terminal according to this embodiment of the present invention, the service provider server 200 and the vending machine service provider server 300 are illustrated as being separate, but the service provider server 200 and the vending machine service provider server 300 may be integrated into a single server. In this case, the functions of the vending machine service provider server 300 may be executed by the service provider server 200. That is, the service provider server 200 may send information about the amount of money to be paid to the vending machine 400 so that a product selected by a purchaser is sold by the vending machine 400, may receive information about the transaction of the product from the vending machine 400, and may request the financial service provider server 500 to approve the transaction of the product.

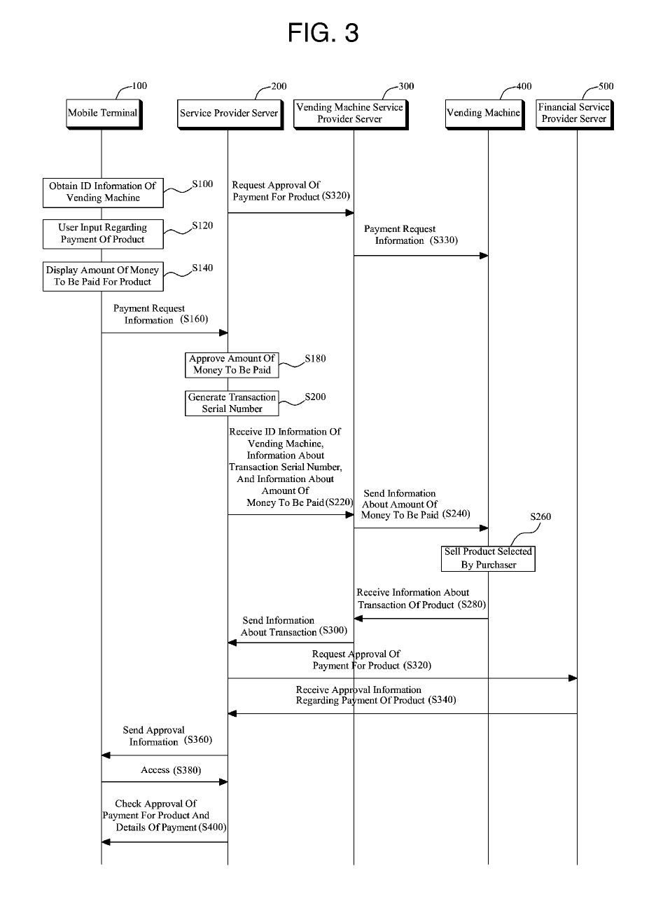

Furthermore, in connection with the following descriptions of FIGS. 3 to 8, the service provider server 200 may perform the functions of the vending machine service provider server 300.

FIG. 3 is a flowchart illustrating a payment process in a payment method for a vending machine using a mobile terminal according to an embodiment of the present invention.

First, the mobile terminal 100 obtains the ID information of the vending machine 400 from a tag attached to the vending machine 400 at step 5100. The tag attached to the vending machine 400 is a printed matter or an electronic tag, such as a Quick Response (QR) code, a Radio Frequency (RF) tag, a Near Field Communication (NFC) tag, or barcode, and the QR code or barcode is displayed on the screen of the mobile terminal 100.

After step S100, the mobile terminal 100 displays the amount of money to be paid for a product sold by the vending machine 400 on a screen at step S140 in response to user input (see step S120) regarding payment for the product. The user input regarding the payment for the product sold by the vending machine 400 may be a PIN number or biometric information. The biometric information may be, for example, a fingerprint.

After step S140, the service provider server 200 receives payment request information from the mobile terminal 100 at step S160, approves the amount of money to be paid at step S180, and generates a transaction serial number at step S200. The payment request information includes the ID information of the vending machine 400, a payment bank, and the amount of money to be paid.

After step S200, the vending machine service provider server 300 receives the ID information of the vending machine 400, information about the transaction serial number, and information about the amount of money to be paid from the service provider server 200 at step S220.

After step S220, the vending machine service provider server 300 sends the information about the amount of money to be paid to the vending machine 400 at step S240 so that the product selected by the purchaser can be sold by the vending machine 400 at step S260.

After step S260, the vending machine service provider server 300 receives information about the transactions of the product from the vending machine 400 at step S280 and sends the information about the transactions to the service provider server 200 at step S300.

After step S300, the service provider server 200 requests the financial service provider server 500 to approve the payment for the product at step S320.

After step S320, the service provider server 200 receives approval information regarding the payment for the product from the financial service provider server 500 at step S340, and sends the approval information to the mobile terminal 100 at step S360.

After step S360, the mobile terminal 100 accesses the service provider server 200 at step S380, and checks the approval of payment for the product and the details of the payment at step S400.

Meanwhile, the step of storing a receipt for the amount of money paid in the mobile terminal 100 may be further included between steps S200 and S220. The purchaser may obtain a receipt in order to provide for a case where the purchaser needs the receipt for the payment of the product.

FIG. 4 is a flowchart illustrating a payment process within the service provider server in the payment method for the vending machine using the mobile terminal according to an embodiment of the present invention. The payment process performed within the service provider server 200 will be described below with reference to FIGS. 2 and 4.

First, the POS server 210 receives payment request information from the mobile terminal 100 at step S161.

After step S161, the PG server 220 receives the payment request information from the POS server 210 at step S163.

After step S163, the payment server 230 receives the payment request information from the PG server 220 at step S165, approves the amount of money to be paid at step S180, and generates a transaction serial number at step S200.

After step S200, the payment server 230 sends the ID information of the vending machine 400, information about the transaction serial number, and information about the amount of money to be paid to the vending machine service provider server 300 at step S220.

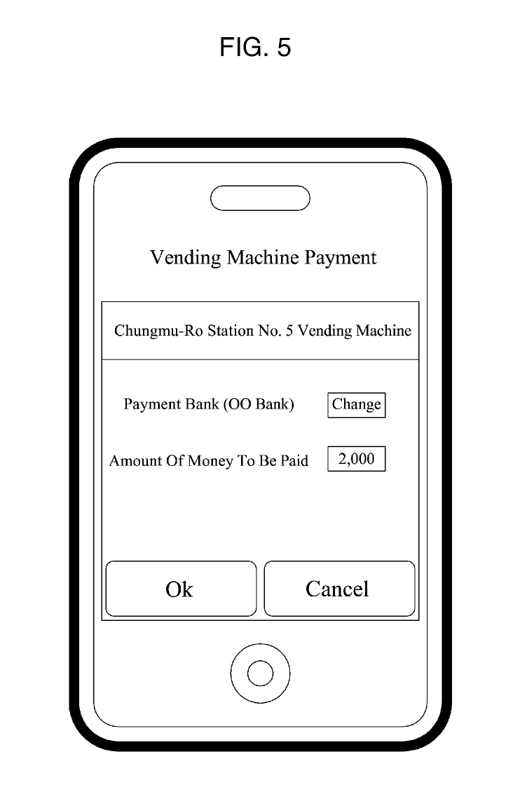

FIG. 5 shows the amount-of-money-to-be-paid input screen of the mobile terminal in the payment system for the vending machine using the mobile terminal according to an embodiment of the present invention. From FIG. 5, it can be seen that ID information (i.e., an area where a vending machine has been installed and a vending machine number that has been assigned within the area) of the vending machine, a payment bank, and the amount of money to be paid are displayed on the screen of the mobile terminal. In this case, the ID information of the vending machine is a Chungmu-ro Station No. 5 vending machine, the payment bank is OO bank, and the amount of money to be paid is 2,000 Won. In the ID information of the vending machine, Chungmu-ro Station is the area where the vending machine is installed, and No. 5 is the vending machine number. A purchaser may select one of several banks, displayed when the purchaser presses “Change”, as the payment bank, the amount of money to be paid is displayed as a basic value, and the purchaser can adjust the amount of money to be paid by pressing “+” or “−”. That is, in most cases, since the price of a beverage displayed on a beverage vending machine is equal to or lower than 2,000 Won, a basic value is 2,000 Won and the purchaser may change the amount of money to be paid into 1,000 Won by pressing “−”.

For example, if the purchaser desires to purchase two cans of Coke each 400 Won in price, the purchaser has only to change the amount of money to be paid into 1,000 Won by pressing “−” and take changes of 200 Won out of the vending machine.

The Chungmu-ro Station No. 5 vending machine, the payment bank (OO bank), and the amount of money to be paid “2,000 Won” are displayed on the screen of the mobile terminal via a payment request application program running on the mobile terminal.

When an “OK” button is pressed on the screen, the payment bank and the amount of money to be paid are entered. However, when a “CANCEL” button is pressed because of a user input error, the displayed payment bank and payment amount are reset, and thus the purchaser may enter the payment bank and the amount of money to be paid again.

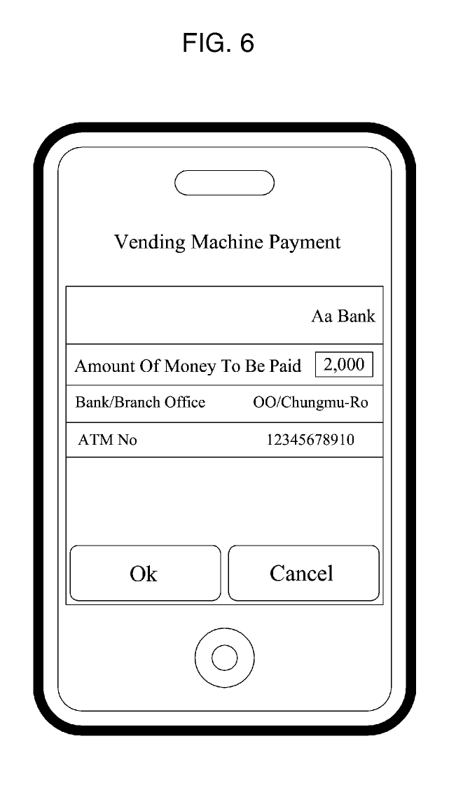

FIG. 6 shows the payment screen of the mobile terminal in the payment system for the vending machine using the mobile terminal according to an embodiment of the present invention. Referring to FIG. 6, a bank name, the amount of money to be paid, a bank/a branch office, and an ATM number are displayed on the screen of the mobile terminal. In this case, the amount of money to be paid is 2,000 Won, the bank/the branch office is OO/Chungmu-ro, and the ATM number is 12345667.

When an “OK” button is pressed on the screen, the amount of money to be paid is determined. When a “CANCEL” button is pressed, payment is canceled.

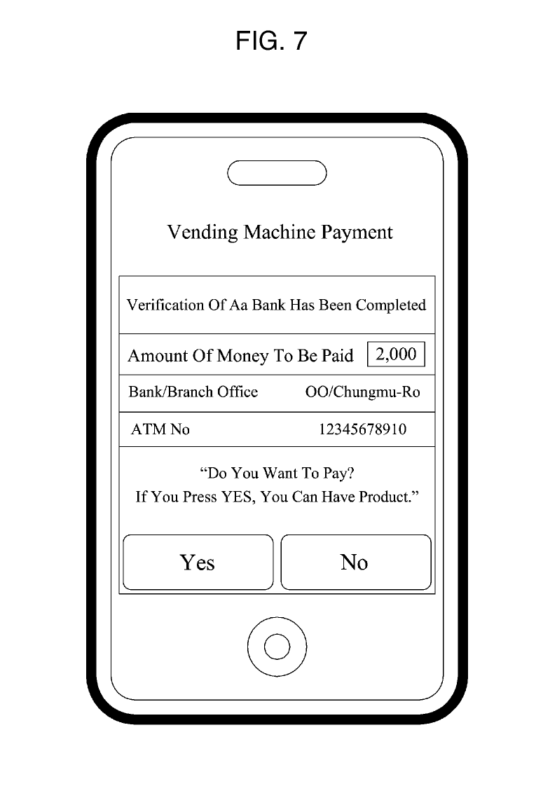

FIG. 7 shows the payment verification completion screen of the mobile terminal in the payment system for the vending machine using the mobile terminal according to an embodiment of the present invention. Referring to FIG. 7, after the verification of the OO bank has been completed, the amount of money to be paid, a bank/a branch office, and an ATM number, and a payment request message are displayed on the screen of the mobile terminal. In this case, the amount of money to be paid is 2,000 Won, the bank/branch office is OO/Chungmu-ro, and the ATM number is 12345667, and the payment request message reads “Do you want to pay? If you press YES, you can take the product.”

In this case, when an “OK” button is pressed on the screen, the payment is completed. When a “CANCEL” button is pressed, the payment is canceled.

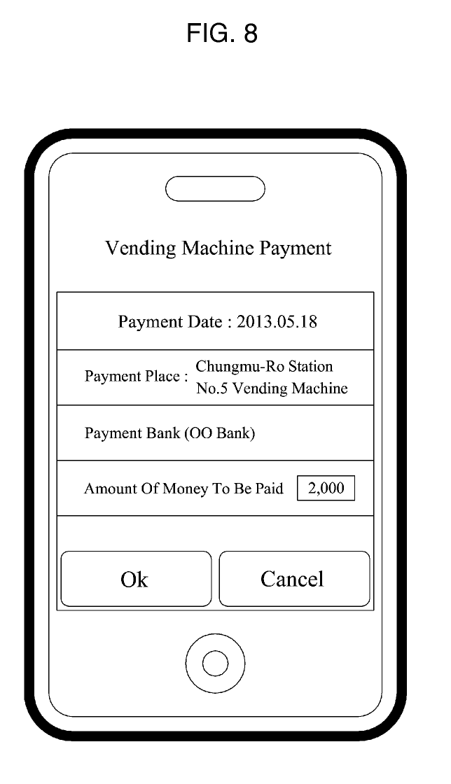

FIG. 8 is a screen on which the details of approval of the payment of the mobile terminal are checked in the payment system for the vending machine using the mobile terminal according to an embodiment of the present invention. Referring to FIG. 8, a payment date, a payment place, a payment bank, and the amount of money to be paid are displayed on the screen of the mobile terminal. In this case, the payment date is May 18, 2012, the payment place is a Chungmu-ro Station No. 5 vending machine, the payment bank is a OO bank, and the amount of money to be paid is 2,000 Won.

When an, “OK” button is pressed on the screen, the approval is completed. When a “CANCEL” button is pressed, the approval is canceled.

Meanwhile, a storage medium (or storage medium) storing a program for implementing the payment method for a vending machine using a mobile terminal can be provided through the payment system and method for a vending machine using a mobile terminal according to the present invention. The storage medium may be computer-executable CD ROM, RAM, or ROM, or a computer-executable floppy disk, hard disk, or optomagnetic disk.

As described above, in accordance with the present invention, when paying for a product sold in a vending machine, a purchaser can conveniently pay for the product using a mobile terminal. Accordingly, a vending machine can be conveniently used even without cash.

Furthermore, in accordance with the present invention, when paying for a product sold in a vending machine, a purchaser can pay for the product using a mobile terminal. Accordingly, a seller does not need to collect money, paid by purchasers, as cash.

Furthermore, in accordance with the present invention, inventory management for products can be easily performed because the vending machine service provider server can check the sales of products sold in a vending machine, and a product in short supply can be refilled in a vending machine because the time at which a product sold by the vending machine is deemed to be in short supply can be precisely checked. Accordingly, products are never sold out in the vending machine.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A payment system for a vending machine using a mobile terminal, comprising:
a mobile terminal configured to obtain ID information of the vending machine from a tag attached to the vending machine, to display an amount of money to be paid for a product sold by the vending machine in response to user input using a PIN number or biometric information for payment for the product on a screen, and to store a receipt for the amount of money to be paid after a service provider server has approved the amount of money to be paid;
the service provider server configured to receive payment request information from the mobile terminal, to approve the amount of money to be paid, and to generate a transaction serial number; and
a vending machine service provider server configured to receive the ID information, information about the transaction serial number, and information about the amount of money to be paid from the service provider server, and to send the information about the amount of money to be paid to the vending machine so that the product can be sold by the vending machine when the product is selected;
wherein the vending machine service provider server receives information about a transaction of the product from the vending machine and sends the information about the transaction to the service provider server;
wherein the service provider server requests a financial service provider server to approve the payment for the product, receives approval information regarding the payment for the product from the financial service provider server, and sends the approval information to the mobile terminal;
wherein the mobile terminal accesses the service provider server and checks the approval of the payment for the product and details of the payment;
wherein the payment request information comprises the ID information of the vending machine, a payment bank, and the amount of money to be paid; and
wherein the ID information of the vending machine, the payment bank, and the amount of money to be paid are displayed on the screen of the mobile terminal when a payment request application program is executed on the mobile terminal, and the ID information of the vending machine is extracted and displayed on the screen of the mobile terminal.

2. A payment system for a vending machine using a mobile terminal, comprising:
a mobile terminal configured to obtain ID information of the vending machine from a tag attached to the vending machine, to display an amount of money to be paid for a product sold by the vending machine in response to user input using a PIN number or biometric information for payment for the product on a screen, and to store a receipt for the amount of money to be paid after a service provider server has approved the amount of money to be paid; and
the service provider server configured to receive payment request information from the mobile terminal, to approve the amount of money to be paid, to generate a transaction serial number, and to send information about the amount of money to be paid to the vending machine so that the product can be sold by the vending machine when the product is selected;
wherein the service provider server receives information about a transaction of the product from the vending machine, requests a financial service provider server to approve the payment for the product, receives approval information regarding the payment for the product from the financial service provider server, and sends the approval information to the mobile terminal;
wherein the mobile terminal accesses the service provider server and checks the approval of the payment for the product and details of the payment;
wherein the payment request information comprises the ID information of the vending machine, a payment bank, and the amount of money to be paid; and
wherein the ID information of the vending machine, the payment bank, and the amount of money to be paid are displayed on the screen of the mobile terminal when a payment request application program is executed on the mobile terminal, and the ID information of the vending machine is extracted and displayed on the screen of the mobile terminal.

3. The payment system of claim 1 or 2, wherein:
the tag is a printed matter or an electronic tag that is one of a Quick Response (QR) code, a Radio Frequency (RF) tag, a Near Field Communication (NFC) tag, or a barcode; and
the QR code or the barcode is displayed on the screen of the mobile terminal.

5. The payment system of claim 1 or 2, wherein the ID information of the vending machine is a combination of an area where the vending machine has been installed and a vending machine number which has been assigned within the area.

6. The payment system of claim 1 or 2, wherein the financial service provider server is any one of a credit financial service provider server, a bank server, an electronic money company server, a prepaid service provider server, and a point service provider server.

11. The payment system of claim 1, wherein the service provider server comprises:
a Point Of Sale (POS) server configured to receive the payment request information from the mobile terminal;
a Payment Gateway (PG) server configured to receive the payment request information from the POS server; and
a payment server configured to receive the payment request information from the PG server, to approve the amount of money to be paid, to generate the transaction serial number, and to send the ID information, information about the transaction serial number, and information about the amount of money to be paid to the vending machine service provider server.

13. A payment method for a vending machine using a mobile terminal, comprising:
a first step of obtaining, by the mobile terminal, ID information of the vending machine from a tag attached to the vending machine;
a second step of displaying, by the mobile terminal, an amount of money to be paid for a product sold by the vending machine on a screen in response to user input using a PIN number or biometric information regarding payment for the product;
a third step of receiving, by a service provider server, payment request information from the mobile terminal, approving, by the service provider server, the amount of money to be paid, and generating, by the service provider server, a transaction serial number;
a third-first step of storing, by the mobile terminal, a receipt for the amount of money to be paid after the service provider server has approved the amount of money to be paid;
a fourth step of receiving, by a vending machine service provider server, the ID information, information about the transaction serial number, and information about the amount of money to be paid from the service provider server;
a fifth step of sending, by the vending machine service provider server, the information about the amount of money to be paid to the vending machine so that the product can be sold by the vending machine when the product is selected;
a sixth step of receiving, by the vending machine service provider server, information about a transaction of the product from the vending machine and sending, by the vending machine service provider server, the information about the transactions to the service provider server;
a seventh step of requesting, by the service provider server, a financial service provider server to approve the payment for the product;
an eighth step of receiving, by the service provider server, approval information regarding the payment for the product from the financial service provider server and sending, by the service provider server, the approval information to the mobile terminal; and
a ninth step of accessing, by the mobile terminal, the service provider server and, by the mobile terminal, checking the approval of payment for the product and details of the payment;
wherein the payment request information comprises the ID information of the vending machine, a payment bank, and the amount of money to be paid; and
wherein the ID information of the vending machine, the payment bank, and the amount of money to be paid are displayed on the screen of the mobile terminal when a payment request application program is executed on the mobile terminal, and the ID information of the vending machine is extracted and displayed on the screen of the mobile terminal.

14. A payment method for a vending machine using a mobile terminal, comprising:
a first step of obtaining, by the mobile terminal, ID information of the vending machine from a tag attached to the vending machine;
a second step of displaying, by the mobile terminal, an amount of money to be paid for a product sold by the vending machine on a screen in response to user input using a PIN number or biometric information regarding payment for the product;
a third step of receiving, by a service provider server, payment request information from the mobile terminal, approving, by the service provider server, the amount of money to be paid, and generating, by the service provider server, a transaction serial number;
a third-first step of storing, by the mobile terminal, a receipt for the amount of money to be paid after the service provider server approves the amount of money to be paid;
a fourth step of sending, by the service provider server, information about the amount of money to be paid to the vending machine so that the product can be sold by the vending machine when the product is selected;
a firth step of receiving, by the service provider server, information about a transaction of the product from the vending machine, and requesting, by the service provider server, a financial service provider server to approve the payment for the product;
a sixth step of receiving, by the service provider server, approval information regarding the payment for the product from the financial service provider server, and sending, by the service provider server, the approval information to the mobile terminal; and
a seventh step of accessing, by the mobile terminal, the service provider server, and checking, by the mobile terminal, the approval of the payment for the product and details of the payment;
wherein the payment request information comprises the ID information of the vending machine, a payment bank, and the amount of money to be paid; and
wherein the ID information of the vending machine, the payment bank, and the amount of money to be paid are displayed on the screen of the mobile terminal when a payment request application program is executed on the mobile terminal, and the ID information of the vending machine is extracted and displayed on the screen of the mobile terminal.

15. The payment method of claim 13 or 14, wherein:
the tag is a printed matter or an electronic tag that is one of a QR code, an RF tag, an NFC tag, or a barcode; and
the QR code or the barcode is displayed on the screen of the mobile terminal.

17. The payment method of claim 13 or 14, wherein the ID information of the vending machine is a combination of an area where the vending machine has been installed and a vending machine number which has been assigned within the area.

18. The payment method of claim 13 or 14, wherein the financial service provider server is any one of a credit financial service provider server, a bank server, an electronic money company server, a prepaid service provider server, and a point service provider server.

23. The payment method of claim 13, wherein the third step comprises:
receiving, by a Point Of Sale (POS) server, the payment request information from the mobile terminal;
receiving, by a Payment Gateway (PG) server, the payment request information from the POS server;
receiving, by a payment server, the payment request information from the PG server, approving, by the payment server, the amount of money to be paid, and generating, by the payment server, the transaction serial number; and
sending, by the payment server, the ID information, information about the transaction serial number, and information about the amount of money to be paid to the vending machine service provider server.

25. A storage medium storing a program for implementing the method set forth in any of claims 13, 14, and 23.
